(19) United States
(12) Patent Application Publication
(10) Pub. No.: US 2011/0112775 A1
(43) Pub. Date: May 12, 2011

(54) Method and device for monitoring an aircraft structure

(76) Inventor: Didier Honoré Bramban, Paris (FR)

(21) Appl. No.: 11/918,810

(22) PCT Filed: Apr. 14, 2006
(86) PCT No.: PCT/FR2006/050351

§ 371 Date: Apr. 1, 2010

(30) Foreign Application Priority Data
Apr. 18, 2005 (FR) 0550982

(51) Int. Cl. G06F 19/00

(52) U.S. Cl. 702/56

(57) ABSTRACT

The invention relates to servicing an aircraft. For this purpose said aircraft is provided with a permanently monitoring device comprising piezo-electric sensors. The inventive method consists in continuously recording signals transmitted by said sensors and in subsequently calculating a fatigue to which the aircraft critical parts are exposed, thereby making it possible to better monitoring said critical parts. Said invention makes it possible to reduce the aircraft servicing costs.

The present invention relates to a method and device for monitoring a structure of an aircraft. It is aimed at taking account more efficiently of the stresses and impacts undergone by an aircraft during its time of use or service life.

In the prior art, the monitoring of an aircraft includes a regular visual inspection of the aircraft, especially at each stopover. There are also major inspection visits in which certain parts of the aircraft are dismounted. In particular, for measurements of solidity, certain parts are replaced. The replaced parts are themselves analyzed in the laboratory. The laboratory analyses comprise non-destructive controls and destructive controls. The non-destructive controls comprise readings of resistance of the dismounted parts under different stresses. If necessary, specialized tools may be designed to measure resistance values of the parts in place. During destructive controls, the limit of resistance of the replaced parts is measured. Their agreeing is deduced therefrom and this agreeing is compared with an expected degree of agreeing.

Monitoring of this kind is imperfect. For it does not take account in real time of the events undergone by the aircraft. It indicates only a partial state at a given point in time. Typically, the falling of an object or tool, or a hailstorm on a vital part of the aircraft such as the radome, leading edges of the wing and tail structure cannot be detected and reported or taken into account in any way. Furthermore, the major inspection visits, which necessitate dismantling and cause the aircraft to be grounded, are complex. They are all the more complex when the investigation needs to be further pursued.

It is the aim of the invention to overcome this problem.

According to the invention, this problem is resolved by providing the aircraft with a permanent monitoring system throughout its useful service life. Typically, this service life comprises phases of flight and phases of waiting in airports or servicing hangars. The monitoring system is an electronic system powered by an avionic electrical power supply. A permanent electrical power supply, especially maintained during the waiting phases, then enables the recording of all the events to which the aircraft is subjected. In this case, the laboratory measurements of resistance can be replaced or at least supplemented by acoustic measurements. Indeed, according to the invention, it has been observed that impacts and shocks, and also major stresses on the structure of the aircraft, give rise to the emission of an acoustic wave at the points of impact, at the position of the shocks or in the zone of stress. Sets of piezoelectric sensors can therefore be installed at the sensitive places, in the vital parts mentioned here above. These sensors are connected to the electronic system and give it information as soon as an event occurs.

Thus, in the invention, it has been observed that major stresses also cause an acoustic wave to be emitted. The nature of this wave is different from that of an impact. The measurement of such an event can provide useful information on the state of the aircraft. To put it simply, an aircraft that takes a frequently storm-ridden route will undergo more of these events. It will be more aged, even if its external appearance is acceptable. According to the invention, the rate of these abrupt applications of stress is measured.

An object of the invention therefore is a method of monitoring a structure of an aircraft in which:

effects of impacts, stresses or agreeing on this structure are measured, characterized in that, to perform these measurements,

piezoelectric sensors are placed on parts of this structure that are to be monitored,

signals delivered by the sensors are read permanently and processed in a central processing unit during a useful service life of the aircraft, on the ground and in flight.

these signals resulting from the presence of an acoustic wave in the structure at the position of the sensors.

An object of the invention is also a device for monitoring a structure and aircraft comprising a device embedded in an aircraft for the detection by acoustic measurement of the effects of impacts, stress or agreeing on this structure and an embedded device for the operating security of this embedded device.

The invention will be understood more clearly from the following description and the accompanying figures. These figures are given by way of an indication and in no way restricts the scope of the invention. Of these figures:

FIG. 1 is a temporal representation of the amplitude of an acoustic signal measured with the method and the device of the invention.

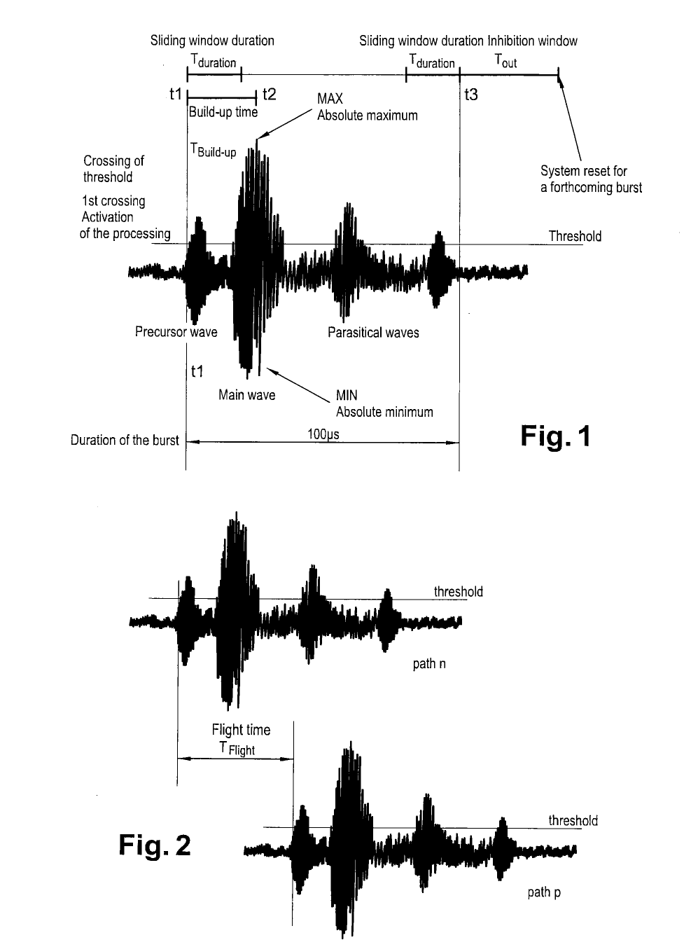

FIG. 2 gives a view, in a case where there are several piezoelectric sensors in the same zone to be monitored, of a time lag between the acoustic signals measured enabling the position of the impact to be located,

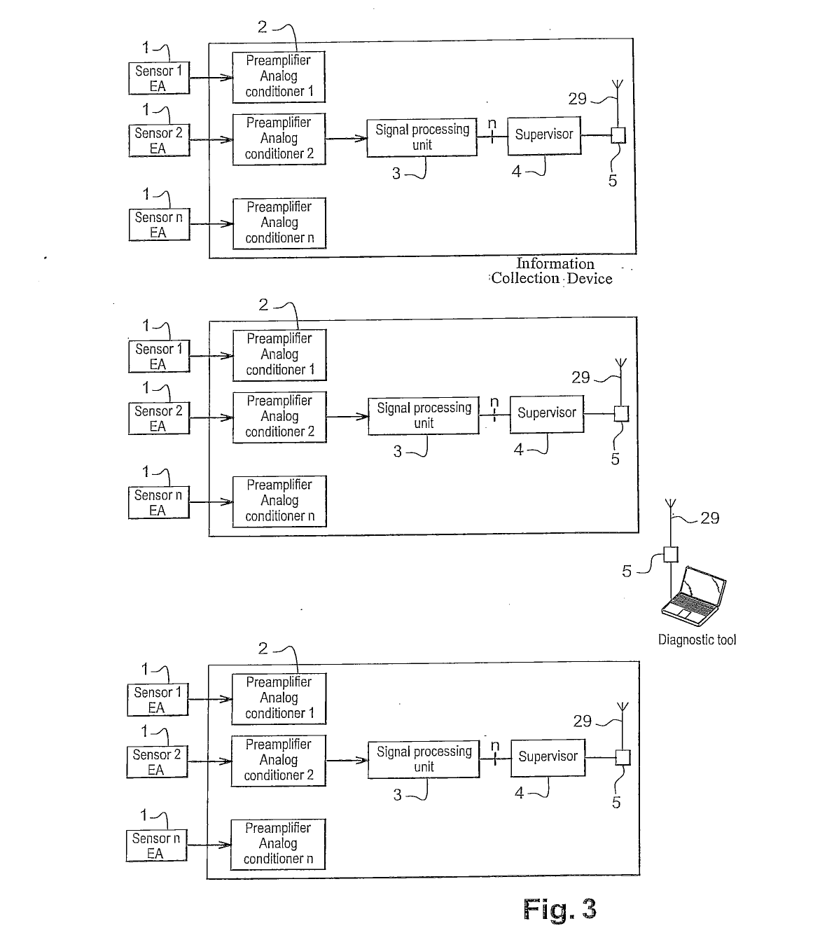

FIG. 3 is a schematic view according to the invention of the distribution of different sensors in the aircraft and of the device for collecting signals produced by these sensors;

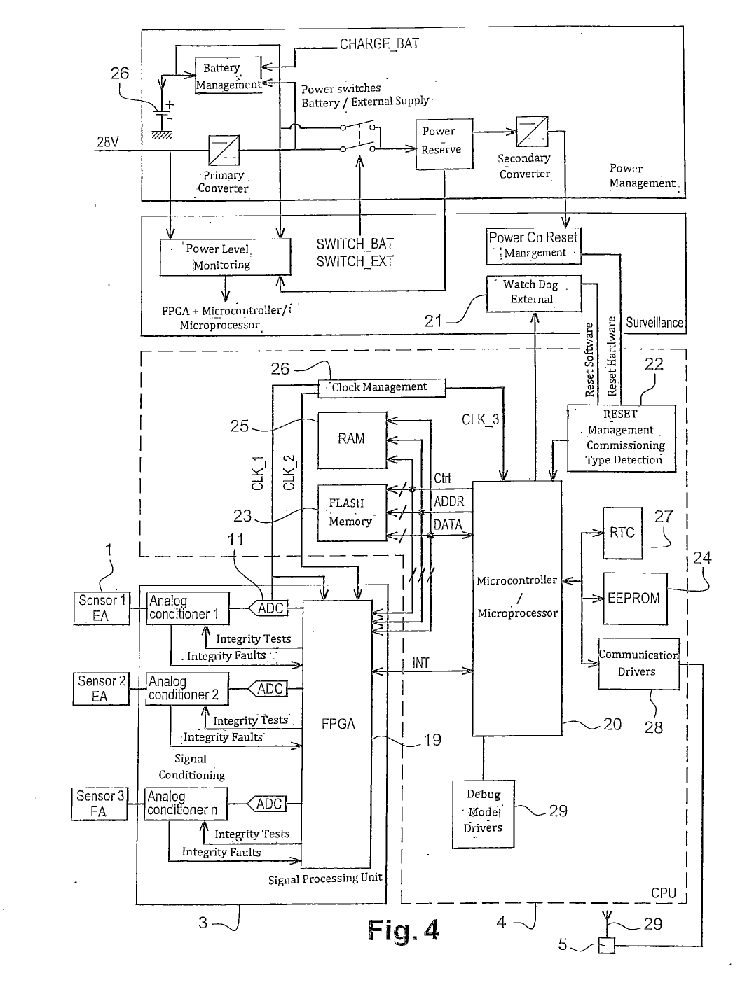

FIG. 4 is a detailed functional view of a recording device of the invention;

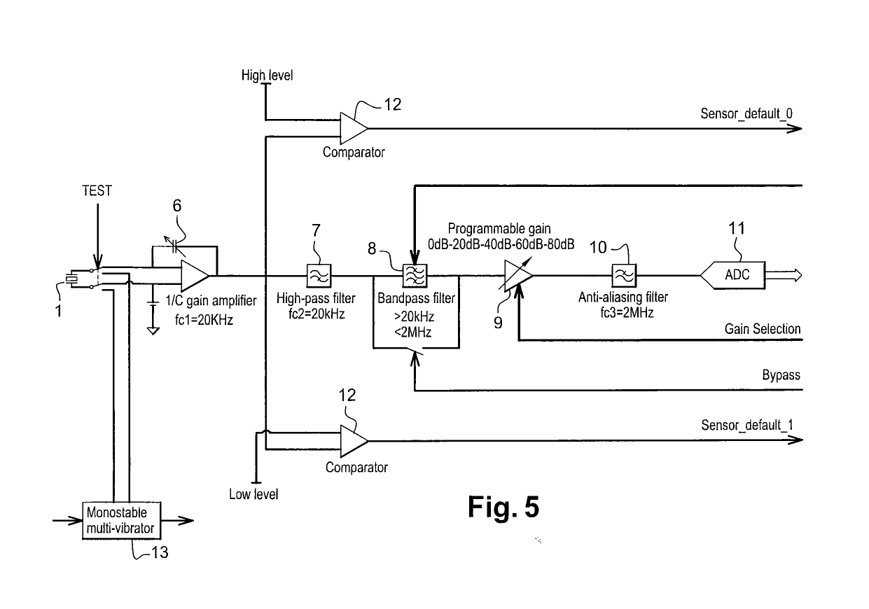

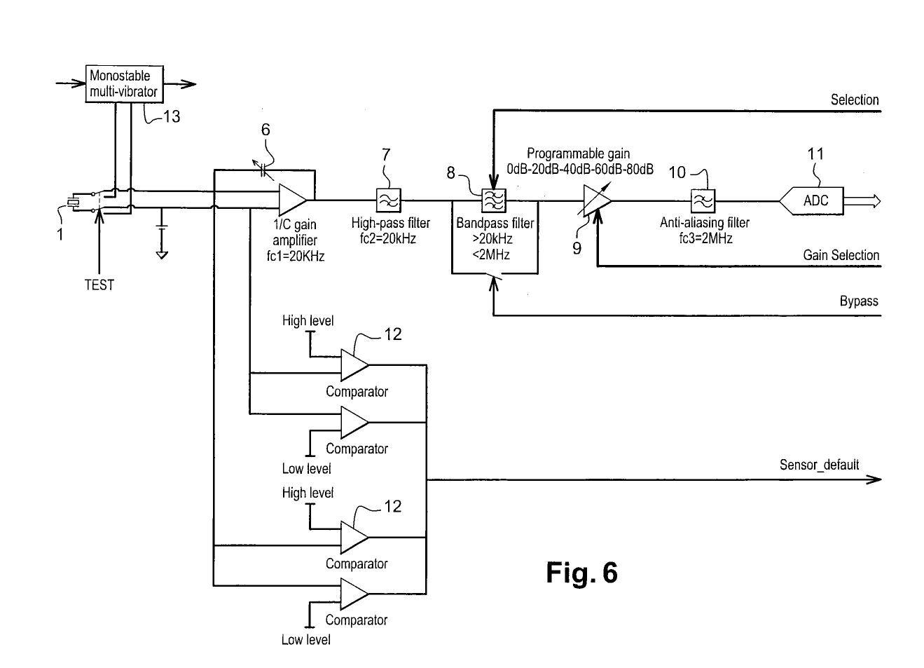

FIGS. 5 and 6 show a device for pre-amplifying, conditioning and performing integrity checks on an acquisition system of the invention;

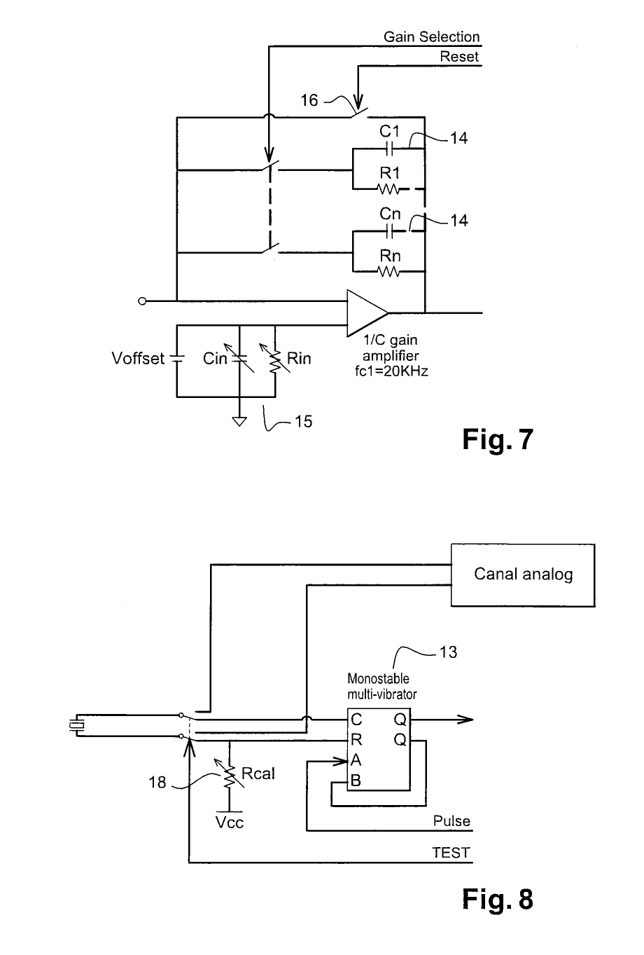

FIGS. 7 and 8 show a device for pre-amplifying signals coming from piezoelectric sensors (trans-impedance assembly) and a mechanism for detecting malfunctions in the piezoelectric sensor.

The principles of acoustic emission are exploited in the invention. Indeed, with the invention, the focus is not so much on the condition of the aircraft parts, well after the occurrence of the events, as it is on transient phenomena occurring at the time itself (within the few milliseconds or seconds that follow the commencement of these phenomena). At the same time, the invention does not prevent the subsequent performance of the major inspection visits referred to here above, especially in order to achieve better correlation between deductions of agreeing and acoustic measurements throughout the service life of the aircraft.

Acoustic testing is a powerful method for examining warp behavior in materials under mechanical stress. Acoustic emission can be defined as a transient elastic wave generated by a rapid release of energy in a material. Acoustic testing is used as a technique of non-destructive controls to detect damage.

Electronic devices using acoustic principles to test materials are specific metrological items and are therefore articles of instrumentation. They are designed for the following particular applications:

applications related to the behavior of materials: especially studies on the spreading of cracks, elasticity, fatigue, corrosion, creep and delamination,

non-destructive controls during the manufacturing process: especially processing of materials, transformations into metal and alloy, the detection of flaws such as inclusions, tempering cracks, pores, manufacturing flaws, warp processes, lamination, forging, drawing, soldering and brazing (inclusions, cracks, lack of material in depth).

monitoring of structures, especially the continuous monitoring of metal structures, periodic tests on pressure chambers, piping, pipelines, bridges, cables,

and the detection of leaks.

Such metrological acoustic devices can be applied in the fields of petrochemicals and chemicals, for storage tanks, reactor chambers, drills, offshore platforms, pipelines, valves. They can also be applied in the field of energy for nuclear reactor chambers, steam generators, ceramic insolants, transformers.

They are also known in aeronautics and space applications, in the laboratory, for the measurement of fatigue and corrosion, and the study of composite and metallic structures.

However in this field, as in any other field, they are not known for being embedded in an aeronautical craft or spacecraft. They are used only in laboratories, on dismounted, stable and, above all, motionless parts. This entails a return to the above-mentioned problem.

The invention uses an acoustic emission system that measures the signal, processes data in time and records, displays and analyses the resulting data. (SENTENCE REPEATED). It is shown in the invention that it is possible to overcome the effects of the vibrations of the aircraft in flight to extract only the useful acoustic signals. Typically, the method of the invention is used to measure bursts of mechanical waves for which the spectral components, in practice, range from 20 kHz to 2 MHz. The acoustic chain is used to analyze the data in real time: the characteristics of the bursts (the high-frequency signals) in the time domain. It is also possible to provide for an analysis of the frequency characteristics of these bursts. It is also possible to localize the acoustic sources by zone or by mesh to automatically recognize and classify the acoustic sources in real time, filter and store the acoustic bursts as a function of their characteristics and extract characteristic data of a phenomenon.

The system of the invention can also be used to manage its own configuration parameters, data transfer and data storage.

The present invention can therefore be applied also in the field of onboard systems, embedded systems, electrical, electronic, programmable electronic systems, equipment related to transportation security. The device of the invention has functions specific to the detection of impacts because it operates during these impacts.

To this end, it has generic functions related to hardware and software operational security. These functions of operational security reside in malfunction detection mechanisms that are exogenous and endogenous to the device. The exogenous functions are mainly, for example, the monitoring and detection of the state of the sensor or of the lines (breaks, short-circuits, leakages in the line of the sensor and even sensor malfunction) or more precisely the permanent detection of the signals delivered by these sensors, the monitoring of the state of the external avionic electrical supply and the boosting of the autonomy of the device by the addition of a backup battery. The endogenous functions must enable the monitoring and detection of the malfunctions internal to the device. These self-tests are chiefly the monitoring of the buffer memories and of the data storage, monitoring of the embedded software in providing for example for a watchdog to prevent the tasks of the processor from being blocked. This functional safety system generally encompasses the potential risks due to the failure of functions that have to be performed by the device of the system. Depending on how critical the detected malfunction is in its nature, the device will adopt a downgraded mode of operation.

The invention therefore relates to a method and device for the detection, processing and recording of impacts or constraints. This device comprises sensors. The sensors are piezoelectric in nature in order to collect the mechanical waves to get propagated in a mechanical structure. The present description uses the following glossary whose meaning must be read with reference to FIGS. 1, 2 and 3:

ADC, Analog to Digital Converter,

TEA, Acoustic Emission,

CND, Non-Destructive Control ,

FPGA, Field Programmable Gate Arrays,

DSP, Digital Signal Processor,

RTC, Real Time Clock,

Flight Time, to indicate a difference between a time of arrival of an acoustic signal on a concerned path (on a piezoelectric sensor concerned by this part) and a time of arrival of the acoustic signal on another path that is reached first.

time of arrival to indicate a time corresponding to a last crossing of a threshold by a signal,

number of alternations, NA: number of crossings of a threshold by the signal starting from the first crossing of the threshold.

Thus, as can be seen in FIG. 1, a measured acoustic signal (measured after electrical conversion as shall be stated further below) has an oscillating shape. Its amplitude crosses a threshold SEUIL at a date t1. It reaches its maximum at a date t2. The difference t2−t1 is the build-up time of the signal. The signal has a duration of one burst, in one example about 100 μs. The duration of bursts is measured between the time t1 and a time t3. The time t3 corresponds besides to a fixed (brief) duration after the last crossing of the threshold SEUIL. In this duration, the envelope of the signal culminates, in this case four times, once for the precursor wave, once for the main wave and twice for the parasitical waves. This breakdown leads to a number of half-wave signals equal to four. Since the measured signal is at high frequency during the bursts, and with a low-pass filter whose cut-off frequency is of the order of fifty times the inverse of a mean duration of a burst, it is possible to extract the envelopes from the half-waves. Furthermore, the signal has an absolute positive maximum amplitude and an absolute negative maximum amplitude, called an absolute minimum amplitude. FIG. 2 shows a flight time (i.e. the difference in time between the starting points of a wave, between the first wave that has arrived at a first sensor and the same wave arriving at another sensor.

FIGS. 3 to 5 show a system comprising software and hardware components. In one example, these embedded hardware and software components form a piece of functional equipment.

In this equipment, the piezoelectric signals of an acoustic nature detected by sensors 1 are converted into analog electrical signals. These analog signals may be amplified to voltage levels usable by distant preamplifiers (preamplifier/analog conditioner) 2. In this case, the preamplifier is shifted to the vicinity of the sensors 1. Preferably, they are amplified by amplifiers integrated into the apparatus. The sensors 1 are distributed by zone in sensitive areas of the aircraft, especially those indicated here above: the radome, the leading edges of aircraft and the tail section. FIG. 3 illustrates the monitoring of three zones.

For example, 24 sensors are distributed in each of four sensitive zones. The amplified signals are conditioned and modulated in order to be conveyed over great distances (10 m-50 m) corresponding to the size of an aircraft. At reception, they may be demodulated, measured when processed in a signal 3 processing unit. The pieces of data from the digital systems are then transmitted to a supervisor 4 who himself transmits the data to the memories and controls the strategy of detection of the malfunctions in the system. A PC or other diagnostic tool 5 prompts the loading and recording of this data and, if necessary, its display. The signal 3 processing unit comprises analog/digital converters, multiplexers, FPGAs circuits and/or DSPs.

Each event in the structure of the aircraft is detected, time-stamped and described essentially in terms of amplitude, half waves, energy, build-up time and duration. As the case may be, the frequency spectrum may be measured. The bursts and the parameters characterizing an event are stored in output buffer memories of the signal 3 digital processing unit pending transfer to the master processor.

The supervisor 4 serves to coordinate the appropriate reading of data from the signal 3 digital processing unit in a single datastream towards buffer memories and large-capacity bulk storage memories enabling the system to take in large quantities of data.

The diagnostic tool 5 is of a personal computer or microcomputer type. It downloads and transfers data from the device to a large-capacity memory, typically a hard disk drive. It may generate the display of data on a display monitor. It processes input/output operations, especially the configuration and calibration of the parameters of the apparatus, for example the threshold value of the threshold SEUIL, the value of the time out after an event. It is possible to define the threshold beyond which it is decided to measure a signal, the threshold being different depending on whether the aircraft is in flight or is at a standstill on the ground. As a variant, a higher signal threshold is determined and, for signals above this threshold, an alarm signal is produced.

In the invention, a system of this kind, further below called a piece of equipment or an apparatus, is implemented along with security functions at the same time. The security functions are required in order to attain a state of security for the equipment or to maintain such a state. Such security functions are designed to achieve a sufficient level of integrity by means of electrical or electronic or programmable electronic systems or software systems or by means of external risk reduction devices.

To this end, the device of the invention comprises, inter alia, the following monitoring and diagnostic modes of operation.

The monitoring mode encompasses the following functions:

functions of detection and classic computation of the event parameters (number of sensor and channel, flight time, duration of the signal, maximum, minimum duration of the signal, energy, number of half waves, build-up time etc);

self-test or monitoring or security integrity functions for each module constituting the system to detect malfunctions exogenous or endogenous to the apparatus;

functions of recording and time-stamping acoustic events, internal and external malfunctions during the service life of the equipment and functions of data transmission on the system digital bus or buses or new means of wire and/or wireless communications;

functions of communication or data transmission on the system digital bus or buses or on new means of wire and/or wireless communications to a distant station. This distant station may be a diagnostic micro-computer or any other apparatus on the same system bus.

Depending on the seriousness of the malfunctions, the apparatus is also capable of working in downgraded modes.

The diagnostic mode consists of a reprogramming of the system for the calibration of the parameters and for transmission of data (event and malfunction parameters) for analysis.

The advantages of the invention are especially the following: modularity of hardware and software architecture, interchangeability of piezoelectric sensors 1, a capacity for being upgraded by the addition of peripherals and drivers, a capacity to reduce the size of the system, monitoring of the mechanical integrity of a structure throughout the phases of operation of said structure.

The function of monitoring operation groups together a function of validation, a function of operating safety and a function of power supply management.

The validation function is indissociable from the function for the detection and computation of the acoustic event parameters. It increases the credibility of the measurement. It necessitates questioning the conditions in which the measurements have been made. In this respect, these conditions are also measured and associated with the measurements on the detected acoustic events.

The function of operating safety can be subdivided into functions relating to safety or integrity of the data against endogenous disturbances (overflow of internal queues, memories, behavior of the processor etc) and exogenous disturbances (electrostatic disturbance, power supply cuts, micro-cuts, damaged cable links, positive leaks and ground leaks, short-circuits, open circuits, damaged sensors). This measurement is made by a measurement of the capacitance characterizing a piezoelectric sensor 1. Tests undertaken to this end correspond to Boolean measurements or results. The tests are cyclical or asynchronous depending on their nature. In order to validate the consistency of certain measurements used for the tests, these measurements are filtered. Confirmation of the malfunction is obtained after several occurrences.

The function of management of the power supply consists of the conditioning of the external power supply with hardware components and the storage of a part of this external energy in an energy reserve. This reserve can be used in the event of a break in the external power supply.

The detailed architecture of the apparatus of the invention comprises, as shown in FIG. 4, four modules. A first module is a signal-processing module SIGNAL PROCESSING, a second module is a processor module CPU, a third module is an energy monitoring module MONITORING, a fourth module is a power supply module POWER SUPPLY.

The signal-processing module groups together the piezoelectric sensors 1, numbered Sensor 1 to Sensor n, analog chains associated with the n sensors, analog-digital converters ADC 11, an FPGA circuit 19 which carries out the real-time, parallel processing of the measurements and the extraction of the parameters from the acoustic signals.

For each sensor, the device of the invention comprises an analog conditioning chain. The conditioning chain is integrated into the digital devices for the computation of acoustic parameters and is not associated with a distant analog chain as in the case of the prior art instrumental and data-recording devices.

An analog chain illustrated in FIG. 5 comprises the following in cascade: a 1/Cn selectable gain load preamplifier 6, for the sensor n, with a fixed cutoff frequency 1/RnCn=20 KHz, a high-pass filter 7 with a cut-off frequency fixed at 20 kHz, a bandpass filter 8 with a cut-off frequency programmable according to the type of piezoelectric sensor 1. This bandpass filter can be shorted by means of a relay made by means of a selector switch or a FET type transistor. It also has a 0 dB, 20 dB, 40 dB, 60 dB, 80 dB selectable gain amplifier 9 in order to make the equipment adaptable to different types of piezoelectric sensors 1, a 2 MHz anti-aliasing filter 10. The load preamplifier 6 is not sensitive to the effects of distance/attenuation like the voltage preamplifier 9. The load preamplifier 6 maintains the sensitivity of the signal independently of the distance of the piezoelectric sensor to the preamplifier 9.

In order to detect the defects of ground leakage and the defects of the voltage power supply of the amplifier 6, comparators 12 are made. These comparators detect useful voltage levels in comparing them with the high and low voltages. They report line malfunctions to the system. The technique offers continuity of monitoring and a high level of confidence in the line.

A monostable multi-vibrator assembly 13 is also used to verify the value of the capacitance of the piezoelectric sensor 1. A measurement of the capacitance of the piezoelectric sensor 1 enables detection of a malfunction in the sensor 1, a break in a line or a short-circuit. This multi-vibrator is connected to the sensor by means of a relay. A signal delivered by the multi-vibrator 13 provides information on the state of the sensor.

The load preamplifier 6 (FIG. 7) is a trans-impedance assembly. This preamplifier converts the electrical load generated by the sensor into a proportional voltage signal. A relay 16 formed by means of a selector switch or a field-effect transistor (FET) mounted on a negative feedback circuit is used therein for the discharge of a selected capacitor 14 Cn and therefore for preparing the apparatus. A selected resistor Rn parallel-mounted with the capacitor 14 Cn forms a high-pass filter with a cut-off frequency 1/RnCn and enables problems of drifts to be avoided. The gain of the load preamplifier 6, 1/Cn, is selectable by means of relays (selector switch or FET transistors). A different resistor Rin 15 and different capacitor Cin 15, both adaptable, are placed in order to balance the assembly and reduce errors of DC or AC power supply shifts caused by input bias currents.

In order to control malfunctions in the sensors of the system, an assembly using a monostable multi-vibrator 17 (FIG. 8) is inserted by direct-action switching. This monostable multi-vibrator 17 delivers a square wave with a width t proportional to RC when a leading edge (or a trailing edge) is sent to the input A of the latch circuit 17, a resistor 18 being a reference resistor placed at two terminals of the monostable multi-vibrator adjustable according to the type of sensor considered. The value of the capacitance of the piezoelectric sensor 1 is proportional to the duration of the square-wave signal. In measuring this time t, we obtain a value of the capacitance C of the sensor 1.

All the n channels are conditioned in parallel by n converter circuits such as the circuit 11 (FIG. 5). The analog/digital converters sample the information from the analog chain with 16-bit precision at a frequency of 20 Mbits/s. The converters are of a parallel type. They transmit signals to the FPGA circuit 19 by a 16-bit data bus. The signals are accompanied by a valid data signal.

The FPGA circuit 19 is responsible for the real-time, parallel processing of information as soon as a programmable threshold is crossed. The measurements processed by the invention are especially the following:

Dating the event (following the value of a register incremented by a 100 ns clock pulse)

Path number

Duration of the signal

Maximum

Minimum

Number of crossings of the threshold

Build-up time

Flight time

The FPGA circuit 19 fulfils the function of real-time acquisition of acoustic events coming from an impact and real-time computation of the parameters characterizing these acoustic events. The FPGA circuit 19 carries out a function of storage of the temporary data in a DPRAM memory internal to the FPGA circuit 19 for the recording of the parameters of an event. The use of such a memory is judicious when the storage time for the measurements in Flash EEPROM type non-volatile memories 23, is too lengthy. A DPRAM type memory is indeed faster then the 70 ns needed to record information in a Flash EEPROM memory of this kind.

Functions for monitoring analog and power supply chains are driven by the FPGA circuit 19. They are integrated into one and the same component.

In the diagnostic mode, the system can send the FPGA circuit 19 all the parameters used to compute acoustic parameters.

A reset signal is available to reset all the latches and registers of the FPGA circuit 19. This signal comes from the processor 20 (FIG. 4).

The CPU model brings together in a group the processor 20 having a random-access memory or RAM interfacing with it, a FLASH type bulk memory 23, a clock management module CLK Management 26, a reset module RESET Management 22, peripherals RTC 27, an EEPROM 24, all these elements being connected through a synchronous serial bus. The processor 20 carries out operations of loading and configuration of the FPGA circuit 19 from parameters stored in the FLASH type bulk memory 23 or EEPROM 24, from the re-reading of the bulk memory for a transfer to the radio transmitter/receiver, from the cyclical integrity check of the acquisition chain, from the check on the integrity of the memories, from the monitoring of the power supply sources and the dating of the event by the retrieval of the value of the clock RTC 27.

The DPRAM internal to the FPGA circuit 19 is accessible to the internal resources of this FPGA circuit 19, in order to write the eight parameters for each path by means of the processor 20. The processor 20 reads the eight parameters for each path so that it can then write data to the FLASH type bulk memory 23. The memory size of the DPRAM is arbitrary. Indeed, the bit rate of the data stream during the writing of the data in the Flash memory 23 (of the order of 1 ms) is far greater than the one corresponding to the minimum time between two consecutive impacts (of the order of about hundred microseconds). Arbitrarily, we shall take a DPRAM depth greater than the size of the data for 10 impacts.

A system of control between the writing of the FPGA circuit 19 and the reading of the processor 20 is in place (address counters). The DPRAM keeps the acoustic events and the types of malfunction that have taken place in memory along with a piece of integrity check information relating to checksum type saved values. The DPRAM is tested by the processor 20 in a reset phase.

The computation of the acoustic data extracted from the bursts is done from registers. A register SEUIL (threshold) contains the value of an arbitrary reference voltage chosen by the operator according to the application. It can be planned especially that the value SEUIL will change depending on whether the aircraft is in a waiting phase (or even a servicing phase) or in flight phase. The parameter is preferably defined during the designing and during the calibration. This parameter is stored in an EEPROM 24. This parameter can be modified through the locating station. A register TDUREE (duration) contains a time constant which is the duration of a sliding window. This sliding window (FIG. 1) enables the FPGA circuit 19 to determine, in real time, the end of an acoustic burst on a path and ends the process of extraction of parameters. The value of the register of this window TDUREE is a parameter defined during the designing phase and during the calibration phase. It is modifiable through the locating station. The window TDUREE is activated as soon as there is a crossing of a threshold. The window TDUREE remains active and can be reactivated so long as there is a crossing of a threshold by the acoustic signal. The window TDUREE is deactivated when no crossing of a threshold by the acoustic signal has occurred during the time TDUREE. This parameter is stored in an EEPROM 24. This parameter can be modified through the locating station.

A register contains a window value TOUT_MAX. The window TOUT_MAX is a time constant corresponding to a range of inhibition of acquisition enabling the secondary echoes to be inhibited. When an acoustic burst is detected on a path, the following samples corresponding to signal rebounds are filtered. Consequently, as soon as the signal on a given path ends, i.e. when the counter TDUREE reaches a limit, and when there has not been any signal above the threshold, a counter TOUT_MAX is activated. So long this counter TOUT_MAX has not reached the window value TOUT_MAX, the FPGA circuit 19 does not take account of the samples on this path. This parameter is stored in an EEPROM 24. This parameter can be modified through the localizing station.

The parameters of acoustic events must be immediately recorded if all the sensors in working condition have reported an acoustic burst after the crossing of the threshold SEUIL. However, it is possible that certain sensors will not report an event (because of a sensor defect or because of an excessively high threshold voltage etc). It is necessary to plan for a duration with a limit stop TVOL_MAX so that the system does not wait for an event indefinitely. This parameter is computed by the processor 20 from the values of the registers TDUREE and TOUT_MAX stored in the EEPROM 24 and loaded into a register of the FPGA circuit 19. The flight time corresponds to (n−1)×(TDUREE+TOUT_MAX) (n is the number of paths).

The condition used to characterize the end of an impact and the authorization of the computations of the acoustic parameters on each path is defined by a condition COND1 or a condition COND2. On a given path, when the signal has been detected, if the counter has reached its limit TDUREE and if no events are detected on the remaining paths other than those for which the signal has already been characterized, and if the counter has reached its limit stop TOUT_MAX, then the condition COND1 is fulfilled. If there are paths on which there have not yet been any samples over the threshold, and if the signal has been characterized at least on one path and if the counter has reached its limit stop TVOL_MAX, then the condition COND2 is fulfilled.

A Watchdog function referenced Watchdog 21 enables a temporal and logic monitoring of the sequence of the software. The Watchdog 21 is a circuit enabling the detection of a defective program sequence of the processor 20, typically when the process is working to no effect. The processor 20 must emit a pulse at a determined frequency toward the Watchdog 21. In the event of malfunction, the individual elements of a program are processed in a period of time in which the clock of the processor 20 shows an anomaly, and the pulse is no longer emitted. This activates an interruption of the Watchdog 21 with respect to RESET Management 22 which processes the nature of the reset and re-initializes the processor 20.

The identification of the type of reset is managed by the RESET Management module 22 in order to determine why the apparatus was rebooted.

The following cases are verified:

re-establishing the external power supply after the apparatus is completely turned off (disconnection of the power supply, cold reset);

re-establishing the external power supply before the apparatus is completely turned off (disconnection of the power supply, hot reset);

Resetting, RESET, caused by an error of refreshing of Watchdog 21 which may be external or internal;

Reset caused by a resetting of the external or internal Watchdog 21 controlled by protocol.

The following are the consequences in terms of functions:

| Type of Reset | Type of Power-On | Observations |
|---|---|---|
| Power On | Nominal | Random access memory |
| | power-on | erased, standard rebooting |
| W/D | None | Random access memory |
| occurrence | | erased, resetting of data, |
| | | reported error-shutdown |
| | | procedure-SHUTDOWN |
| W/D by | Fast power-on | Random access memory |
| protocol | by protocol | erased, resetting of data, no |
| | | error reported |
| Reset power | Fast power-on | Réset power supply |
| supply level | | |

The bulk memory is a FLASH memory 23 of a size sufficient to contain the hardware configuration of the processor 20, the starting program, the application software, the set of recordings of the acoustic measurements, and the recording of the malfunctions other than those of the bulk memory.

Cyclical tests are performed by the processor 20 to validate the integrity of the data.

The EEPROM 24 stores the configuration parameters for the acoustic measurements and the parameters used for the self-tests (threshold, filters etc) and stores the defects of the bulk memory (defective sector fault).

Tests of integrity comprise tests of access control, addressing, writing, reading, storage (information for checking the integrity of the values saved of the checksum type). Depending on the nature of the tests, they are cyclical or asynchronous.

The random access memory RAM 25 is a random access memory of sufficient size used for the temporary storage of the variables of the software and the software under execution. Tests are performed by the processor 20 to check the validity of the RAM 25. Cyclical tests consist of a periodic reading of the expected values expected in reserved memory zones and stored values (information on checksum type integrity checks for the saved values). These tests are complemented by promised tests which consist in detecting malfunctions during the addressing, writing, storage (checksum type information for integrity checks on stored values) and reading.

The CLK Management module 26 distributes the clocks through the converters 11, the FPGA circuit 19, the processor 20. It also has clocked drivers in order to ensure low drift values, eliminate the crossing of limits in adapting the impedance of the drive circuit to the impedance of the lines by the series-connected resistors 19. The clock circuit is associated with a phase control loop.

The RTC circuit 27 is a pack associated with a quartz element giving a date with the format: year-month-day-hour-minute-second. The precision is to the order of one second. Depending on the type of component chosen, its interface may be in the SPI or 12C format. This component is programmed at least once during the service life of the card (for the resetting of the time). There is no corrective device provided for the drift of this clock.

The RS232 driver 28 is a specific MAX232 type circuit designed to set up a link to a checking microcomputer by means of an RS232 link. This circuit enables a conversion of the TTL signals into RS232 type signals and vice versa. Two-way diodes are wired to the input/output signals in order to protect the circuit in the event of excess voltage. The dedicated circuits are protected against the shorting of the paths.

The communications protocol on the bus is a standard serial synchronous SPI or I2C protocol. A serial bus well suited to this type of application is the one using the I2C protocol. It is possible to add peripheral drivers such as EEPROMs 24, RTCs 27, bus communications drivers in order to increase the functions of the device of the invention. In particular, the state of the bus between the sensors and a central processing unit is tested to enable the permanent reading of the signals of the sensors.

Communications can be obtained by means of wireless communications means 29. The collection of the data recorded by the equipment is possible in all cases locally using a wire series link. The wireless communications link enables the collection of data over a distance of about 10 m. To do this, an 802.11 type module on a 2.4 GHz carrier is used. The communications are done from point to point.

The monitoring module illustrated in FIG. 4 detects excessively high current levels as well as inrush currents (short-circuits). The MONITORING module detects malfunctions due to a power supply fault and protects the system against surge voltages. A surge voltage or an under-voltage is detected early enough so that all the outputs can be put into a safety position by the power-off software or so that there is a switch-over to a second battery power supply unit. The voltage MONITORING module monitors the secondary voltages and places the system in the safety position if the voltage is not within the specified range (upper and lower thresholds). The MONITORING module powers the system off with a safety stop in cutting off the power supply while at the same time recording all the critical information on security.

The POWER SUPPLY module illustrated in FIG. 4 is a power supply block consisting of a D.C./D. C. converter compliant with the DO-160 (category B) CEM avionics standards.

In addition to the generation of voltages needed for the operation of the CPU module, the power supply unit enables switching to a battery'type energy reserve in the event of malfunctioning of the external power supply source.

The state diagram of the system comprises the following states:

POWERING-ON step

The equipment enters the POWERING-ON phase after the reset signal RESET, controlled by the RESET Management sub-system 22 has been activated.

If a drop or loss of power supply voltage of the system lasts longer than TBAT1 (EEPROM 24 parameter) and if no RESET signal is activated from Watchdog 21 then, in the event of a return to a proper voltage levels in a duration Tpower_recovering (parameters stored in EEPROM 24), the system will have to perform a reset operation testing the functions of the power supply.

Behavior of the power-on step

When the system is powered on, the equipment tests all the vital functions of the system: integrity of the ROM, RAM, bulk memories, EEPROM 24, information coming from AND RESET Management 22, disconnection of the power supply, the voltage level of the external power supply, the capacitance of the energy reserve, the integrity of the sensors, positive leaks and ground leaks, configuration (number of sensors present).

The relay 16 (RESET) mounted on the negative feedback circuit is placed in a closed position to discharge the capacitor 14 Cn selected and to enable the preparation of the apparatus.

The tests are software tests. In no case does the system enter a process of acoustic measurement.

The system leaves the power-on step for normal operation when the configuration of the lines has been verified and if the power supply voltage level is acceptable and/or if the capacitive type energy reserve is charged to an acceptable level.

The equipment remains in the power-on step if the power supply voltage is outside the range.

The power-on step starts again so long as the tests on the ROM and RAM 25 are false.

The equipment leaves the power-on step for the shutdown step if there is at least one defect for which the error strategy implies the shutdown of the apparatus.

The selector switch between the piezoelectric sensor 1 and the analog chain is positioned on the load preamplifier 6. The contacts of the relay 16 (RESET) mounted on the negative feedback circuit of the preamplifier is placed in the open position.

The apparatus enters the step in the normal working phase at the end of the power-on step.

Periodic diagnostics

During the normal operating phase, the apparatus executes periodic self-tests. The apparatus must validate the conditions in which the acoustic measurements are performed (checks on the efficient running of the algorithm, stack overflow, control of storage of the data in the memories etc).

During the nominal operating phase, the apparatus carries out diagnostics on asynchronous actions (communications protocol, access control, reading/writing to memories, crossings of threshold for the leaks).

If a defect is related to a shutdown strategy, or else if a drop or loss of power supply voltage of the device or apparatus lasts longer than TBAT1 (parameter in EEPROM 24), then the apparatus goes into cut-off or shutdown mode.

When a critical error is detected, the apparatus enters shutdown mode. Only the power supply voltage and the micro-cuts still diagnosed. Wireless communications are still controlled by the wireless controller and continue to be diagnosed.

Wireless communications are authorized. A disconnection of the power supply causes the device or apparatus to be powered off. The apparatus starts again in going into the power-on step if the mains supply powers the unit again and if no RESET signal has already been activated.

The equipment defines a partial shutdown for defects on the measurement lines: leakages on the line. The diagnosis of the defective line is prohibited and the other lines remain functional. The defect is reported by the system remains in its state.

1. A method of monitoring a structure of an aircraft wherein
effects of impacts, stress or agreeing aging on the-structure are measured by a monitoring system having a central processing unit,
wherein the method comprises;
positioning piezoelectric sensors are placed on parts of the-structure that are to be monitored;
reading signals delivered by the sensors; and
processing the signals in the central processing unit during a useful service life of the aircraft, on the ground and in flight.
wherein the signals are a resulting from the a presence of an acoustic wave in the structure at a position of the sensors,

2. The method according to claim 1, wherein reading signals further comprises:
validating an operation of a set formed by sensors connected to the central processing unit.

3. The method according to claim 1, further comprising:
coupling the monitoring system to a constant, uninterruptible electrical power supply; and monitoring the electrical power supply.

4. The method according to claim 1, further comprising:
testing a state of a communications bus between sensors and the central processing unit is during reading.

5. The method according to claim 1, wherein reading signals comprises measuring, at least one characteristics of a signal, wherein the at least one characteristic is selected from the group consisting of:
concerned sensor references,
a date of a measured, acoustic event,
a frequency of a measured acoustic wave,
a number of half waves of a signal for which the value is above a threshold,
a duration of a burst of half waves of the signal for which the value is above a threshold,
a maximum value of the signal,
a minimum value of the signal,
a build-up time of the signal,
a frequency spectrum of the signal,
a delay of the signal, and combinations thereof.

6. The method according to claim 1, further comprising one or more of the following operations:
verifying the presence of the detectors;
checking with a watchdog function to ascertain that the processing unit is not operating in a loop;
monitoring four zones of the aircraft with 24 sensors per zone, these zones being a radome of the aircraft, leading edges of wings of this aircraft and a tail unit of this aircraft;
measuring the signal for about 100 microseconds at each acoustic event;
measuring the signal situated in a frequency band ranging from 20 kHz to 2 MHz;
defining a threshold beyond which it is decided to measure a signal, this threshold being different depending on whether the aircraft is in flight or on the ground;
storing the signal in a fast buffer memory to record the events whose duration is shorter than a time of storage in an EEPROM type memory; and
determining an upper signal threshold and, for signals above this threshold, producing an alarm signal.

7. A device for monitoring a structure and of aircraft comprising:
a detection device positioned on an aircraft, wherein the detection device is operable to detect, by acoustic measurement the effects of impacts, stress, aging, and combinations thereof, of the-structure; and
a security device for the operating security of the detection device.

8. The device according to claim 7, wherein the device further comprises means for monitoring an analog signal produced by the detection device.

9. A monitoring apparatus for monitoring a structure of an aircraft wherein effects of impacts, stress or aging on the structure are measured, the monitoring apparatus comprising:
a plurality of piezoelectric sensors positioned on parts of the structure that are to be monitored; and
an electronic assembly powered by an electrical power supply, wherein the electronic assembly includes:
a signal processing unit having at least one of an analog/digital convertor, a multiplexer, a field-programmable gate array circuit, and a digital signal processor, and
a diagnostic tool comprising a central processing unit and a large-capacity memory,
wherein the monitoring apparatus monitors signals resulting from the presence of an acoustic wave in the structure at the position of the sensors during a useful service life of the aircraft, both on ground and in flight.

10. An electronic device for monitoring a structure of an aircraft, the device comprising:
acoustic sensors coupled to structural portions of the aircraft to sense acoustical signals;
a recording system operably coupled to the sensors to receive and record the acoustical signals in real time, wherein the sensed acoustical signals arise from impact to, stress, or flexure of portions of the aircraft during a useful life of the aircraft, both on ground and in flight.

11. The electronic device of claim 10, wherein the electronic device is carried onboard the aircraft throughout the useful life of the aircraft.

12. The electronic device of claim 10, wherein the electronic device is powered by a continuous and uninterruptible electrical power supply.

13. The electronic device of claim 10, wherein the acoustic sensors comprise piezoelectric sensors.

14. The electronic device of claim 10, wherein the acoustic sensors are coupled to portions of the aircraft selected from the group consisting of a radome, leading edges of wings, a tail unit, and combinations thereof.
